(19) United States
(12) Patent Application Publication
(10) Pub. No.: US 2018/0348522 A1
(43) Pub. Date: Dec. 6, 2018

(54) PHOTOCHROMIC BACKGROUND LAYER FOR AUGMENTED REALITY IMAGE ENHANCEMENT

(71) Applicant: Applied Materials, Inc., Santa Clara, CA (US)

(72) Inventors: Michael Yu-tak YOUNG, Cupertino, CA (US); Wayne MCMILLAN, San Jose, CA (US); Rutger THIJSSEN, Sunnyvale, CA (US); Robert Jan VISSER, Menlo Park, CA (US)

(21) Appl. No.: 15/992,831

(22) Filed: May 30, 2018

Related U.S. Application Data
(60) Provisional application No. 62/515,379, filed on Jun. 5, 2017.

(51) Int. Cl. G02B 27/01; F21V 8/00

(52) U.S. Cl. CPC G02B 27/0172; G02B 6/0076; G02B 6/0031; G02B 6/0026; G02B 6/005; G02B 2027/0118; G02B 6/0038

(57) ABSTRACT

Embodiments described herein relate to a waveguide imaging structure. The waveguide imaging structure generally includes an input coupling region, a waveguide region, and an output coupling region. In certain embodiments, a photochromic material layer is disposed on an output coupling region of the imaging structure. Also described herein are methods and materials for forming the photochromic material layer.

### CROSS-REFERENCE TO RELATED APPLICATIONS

This application claims benefit of U.S. Provisional Patent Application No. 62/515,379, filed Jun. 5, 2017, the entirety of which is herein incorporated by reference.

### BACKGROUND

### Field

Embodiments of the present disclosure generally relate to augmented reality waveguides. More specifically, embodiments described herein relate to a photochromic background layer for display of augmented reality images.

### Description of the Related Art

Virtual reality is generally considered to be a computer generated simulated environment in which a user has an apparent physical presence. A virtual reality experience can be generated in 3D and viewed with a head-mounted display (HMD), such as glasses of other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. The lighting conditions of a user's ambient environment frequently change and may not adequately be controlled to ensure a desirable image display. As such, light from an ambient environment may washout and/or decrease the clarity of a displayed virtual image. One approach to solve such a problem is to increase the display brightness. However, increasing the display brightness is often inadequate to overcome many ambient lighting environments and also utilizes more power, thus, limiting the usable duration of such devices.

Accordingly, what is needed in the art are improved augmented reality display devices.

### SUMMARY

In one embodiment, an imaging structure apparatus is provided. The apparatus includes a first waveguide and a second waveguide spaced from the first waveguide. The first waveguide comprises a first surface of the imaging structure and the second waveguide comprises a second surface of the imaging structure and the first surface is disposed opposite the second surface. An input coupling region corresponds to a first area of the first waveguide and the second waveguide and an output coupling region corresponds to a second area of the first waveguide and the second waveguide. A photochromic material layer is disposed on the second surface corresponding to the output coupling region.

In another embodiment, a display device apparatus is provided. The apparatus includes a microdisplay, imaging optics, and an imaging structure having an input coupling region, a waveguide region, and an output coupling region. The imaging structure includes a plurality of waveguides aligned in a stacked arrangement and interstitial spaces are disposed between each waveguide. A photochromic material layer is disposed on a surface of at least one waveguide and the photochromic material layer is disposed on the surface approximating the output coupling region.

In yet another embodiment, an imaging structure fabrication method is provided. The method includes fabricating an imaging structure comprising a plurality of waveguides where a first waveguide defines a first surface of the imaging structure and a second waveguide defines a second surface of the imaging structure opposite the first surface. A mask is deposited on the second surface, the mask is patterned to expose an output coupling region of the imaging structure, and a photochromic material layer is deposited on the output coupling region of the second surface.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a schematic, cross-sectional view of a multiple waveguide imaging structure according to an embodiment described herein.

FIG. 2 is a schematic, cross-sectional view of a multiple waveguide imaging structure according to an embodiment described herein.

FIG. 3 is a schematic, cross-sectional view of a multiple waveguide imaging structure according to an embodiment described herein.

FIG. 4 is a flow chart of a method for fabricating a waveguide imaging structure having a photochromic material disposed thereon according to an embodiment described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein relate to a waveguide imaging structure. The waveguide imaging structure generally includes an input coupling region, a waveguide region, and an output coupling region. In certain embodiments, a photochromic material layer is disposed on an output coupling region of the imaging structure. Also described herein are methods and materials for forming the photochromic material layer.

Imaging structures and display apparatus described herein may be implemented in an imaging unit of a head-mounted display (HMD), such as glasses, goggles, headset, or other type of wearable display device. Imaging units incorporating the imaging structures described here can generate a virtual image to appear as part of the environment for augmented reality imaging and/or viewing. It is also contemplated that various elements of the embodiments provided herein may be advantageously utilized in other imaging fields, such as virtual reality and the like.

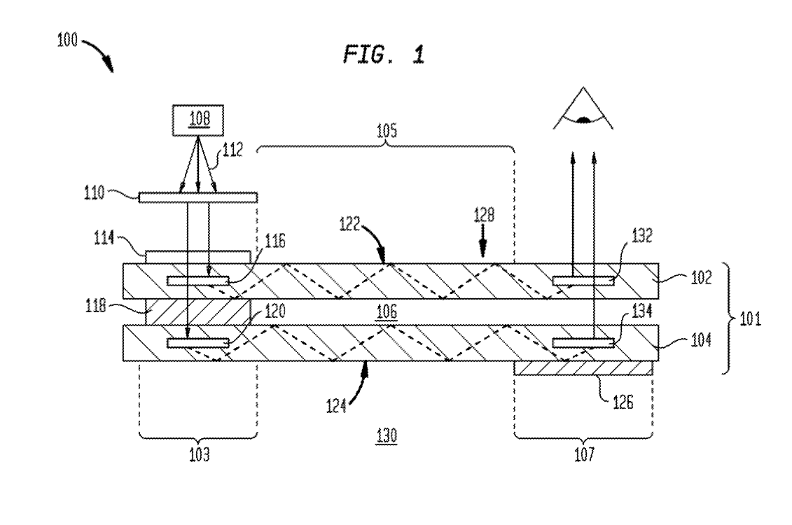

FIG. 1 is a schematic, cross-sectional view of a multiple waveguide imaging structure 101. The imaging structure 101 is implemented in a display apparatus 100 which is configured for either augmented, virtual, and mixed or merged reality applications as well as other display applications, for example, hand held display devices. Embodiments disclosed herein are described with regard to augmented reality apparatus.

The display apparatus 100 includes a first waveguide 102 and a second waveguide 104 for see-through viewing of an ambient environment 130 through the imaging structure 101, such as for a user viewing the environment 130 from a perspective 128. When implemented in a display apparatus 100, a first surface 122 of the first waveguide 102 is disposed adjacent to and facing a user's eye 111. A second surface 124 of the second waveguide 104 is disposed opposite the first surface 122 and adjacent to and facing the ambient environment 130. The first waveguide 102 and the second waveguide 104 have a planar morphology such that the first surface 122 and the second surface 124 are parallel to one another. Although illustrated as being planar, it is contemplated that the first waveguide 102 and the second waveguide 104 may be curved, depending upon the desired application.

The display apparatus 100 further includes an image microdisplay 108 and an imaging optic 110 that implements an input mechanism to direct light 112 of a generated, virtual image into the waveguides 102, 104 where the light of the virtual image is then propagated in the waveguides 102, 104. Generally, the imaging structure 101 and the associated waveguides 102, 104 include an input coupling region 103, a waveguide region 105, and an output coupling region 107. The input coupling region 103 receives light (a virtual image) from the microdisplay 108 and the light travels through the waveguide region 105 of the imaging structure 101 to the output coupling region 107 where the user's perspective 128 and field of view enable visualization of a virtual image overlaid on the ambient environment 130.

The image microdisplay 108 is a high resolution display generator, such as a liquid crystal on silicon microdisplay, that projects the light of the virtual image through the imaging optic 110 into the waveguides 102, 104. The imaging optic 110 can be implemented as a collimating lens and the light emitted from the image microdisplay 108 and imaging optic 110 is polarized in certain embodiments. In other embodiments, the light is unpolarized. It is contemplated that the image generation apparatus (e.g., the image microdisplay 108 and imaging optic 110) may be combined with other lenses or optical elements.

In one embodiment, the imaging structure 101 includes a polarization switch 114 that is utilized to rotate or cycle the polarization of the light 112 through polarization orientation angles before the light is reflected into the waveguides 102, 104. The waveguides 102, 104 include input reflectors 116, 120, respectively, that are angled so that the first waveguide 102 has a first field of view and the second waveguide 104 has a second field of view different from the first field of view. In one embodiment, the input reflectors 116, 120 may be grating elements configured to deflect the light 112 propagating through the input reflectors 116, 120. In certain embodiments, the input reflectors 116, 120 are also wavelength filters selected to allow specific wavelengths of light to be reflected, refracted, or transmitted through the input reflectors 116, 120. For example, an input reflector 116 may be selected to reflect red light while allowing blue and green light to pass through, while the input reflector 120 is selected to reflect green and blue light.

In one embodiment, the first waveguide 102 includes the input reflector 116 which is implemented as a polarizing beam splitter or other type of optical filter to reflect the light that enters at a first polarization orientation angle so that the light propagates down the waveguide 102. The input reflector 116 is implemented to pass through the light 112 that enters the first waveguide 102 at a second polarization orientation angle as the polarization switch 114 rotates or cycles the polarization of the light 112 through the first and second polarization orientation angles. Similar to the first waveguide 102, the second waveguide 104 input reflector 120 may also be implemented as a polarizing beam splitter.

The imaging structure 101 also includes a half wave plate 118 or similar optical element to change the light 112 (e.g. alter the polarization orientation of the light or select for a desired wavelength) that passes through the first waveguide 102. An interstitial space 106 is disposed between the first waveguide 102 and the second waveguide 104. The interstitial space 106 is filled with a material having an index of refraction different than an index of refraction of a material selected for the first and second waveguides 102, 104. For example, the interstitial space 106 may be filled with air which has an index of refraction of about 1.0 while the waveguides 102, 104 may be fabricated from a transparent glass-like material having an index of refraction of greater than about 1.5. Examples, of materials suitable waveguide materials include glass, quartz, sapphire, and other suitable transparent or substantially transparent materials. By utilizing material with sufficiently different indices of refraction, propagation of the light through the waveguides 102, 104 may be enhanced by total internal refraction, or some degree thereof.

Generally, the input reflectors 116, 120 are disposed in the input coupling region 103 of the imaging structure 101 and light propagates within the waveguides 102, 104 through the waveguide region 105 to the output coupling region 107. Output elements 132, 134 are disposed within the first and second waveguides 102, 104, respectively. The output elements 132, 134 are generally considered to be output diffractive devices which direct light propagating through the waveguide region 105 toward a user's eye 111. Examples of suitable output elements 132, 134 include focus elements implemented to change or adjust the focus depth of a displayed virtual image. One example of a focus element is a Switchable Bragg Grating. Alternatively, the output elements 132, 134 may be more simplistic grating structures selected to reflect light in a direction aligned with a user's field of view.

The imaging structure 101 also includes a photochromic material layer 126 disposed on the second surface 124 of the second waveguide 104 adjacent the ambient environment 130. The photochromic material layer 126 is disposed over an area approximating the output coupling region 107. In this embodiment, the waveguide region 105 and the input coupling region 103 remain substantially free of the photochromic material layer 126. By utilizing the photochromic material layer 126 on the output coupling region 107, improved ambient light suppression and reaction to changing ambient light conditions provides for improved image display and viewing characteristics by suppressing ambient background light. It is believed that by disposing the photochromic material layer 126 on the output coupling region 107 preferentially to other regions may increase the display contrast which improves the brilliancy of the virtual image displayed.

Photochromic materials typically decrease transmission reversibly when exposed to radiation, such as light from an ambient environment. For example, upon exposure to bright fight, the photochromic material reacts by reducing the transmission of light therethrough. Alternatively, in a dim light environment, the photochromic material reacts by increasing the transmission of light therethrough.

Examples of materials suitable for utilization as the photochromic material layer 126 include, without limitation, titanium oxide, zinc oxide, tungsten oxide, nickel oxide, FeTiO₃, CdFe₂O₄, YFeO₃, SrTiO₃, CdO, V₂O₅, Bi₂O₃, PbO, Ta₂O₅, Nb₂O₅, SnO₂, ZrO₂, CeO₂, oxygen containing hydrides, such as oxygen containing yttrium hydrides (e.g. YHₓO_{Y}), mixed oxides, such as lead titanate, lead-lanthanum titanate, oxides containing metallic or polymeric inclusions, zinc sulfide, lead sulfide, cadmium sulfide, other metal sulfides, oxide/sulfide composites, selenides such as ZnSe, ZrSe₂, HfSe₂ and InSe, metallic or other dopants in any such compounds, compound semiconductors such as GaP, semiconductors of other compositions, such as doped silicon or germanium doped silicon carbide, photoconducting and semiconducting polymers such as polyvinyl carbazoles, polythiophenes, polyphenylene vinylenes, polyphenylenes and polyanilines.

Other semiconductors or organic or inorganic dyes may be incorporated in the photochromic material layer 126. The photochromic material layer 126 can also be a composite of several of the materials described above where one or more of the materials may be (homogeneously or heterogeneously) dispersed in the coating matrix or can consist of sequentially deposited layers. The photochromic material layer 126 can further be treated or coated to provide added functionality, such as enhanced hydrophobicity, hydrophilicity, corrosion resistance, charge transport and the like.

The photochromic material layer 126 may be formed on the second waveguide 104 by various methods, for example, by wet chemical methods, such as by spin coating, roller coating, dip coating, or spray coating and the like. The photochromic material layer 126 can deposited by chemical vapor deposition (CVD) or physical vapor deposition (PVD), such as by plasma assisted chemical vapor deposition, evaporation, including electron beam evaporation and sputtering. Examples of suitable photochromic material layer deposition apparatus include CVD and PVD tools available from Applied Materials, Inc., Santa Clara, Calif.

The photochromic material layer 126 has a thickness in the range of about 10 nanometers to about 100,000 nanometers. However, any thickness of the photochromic material layer 126 which will provide sufficient radiation attenuation when exposed to an illumination source may be employed. The refractive index, porosity, thickness, and other microstructural details of the photochromic material layer 126 may also be manipulated by the method of preparation and choice of composition in order to impart variations in device behavior such as speed and depth of coloration, sensitivity to the spectrum of radiation, self-bleaching duration, and overall transparency of the material.

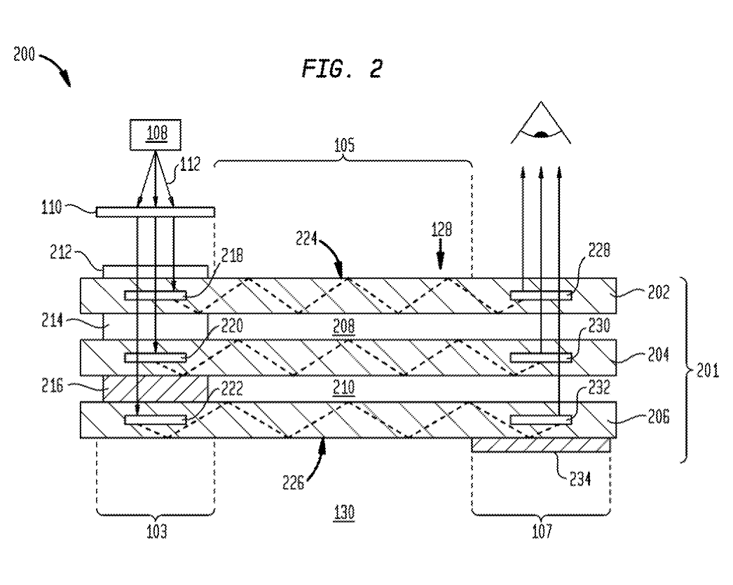

FIG. 2 is a schematic, cross-sectional view of a multiple waveguide imaging structure 201 according to an embodiment described herein. The imaging structure 201 is implemented in a display apparatus 200 which is configured for either augmented, virtual, and mixed or merged reality applications, as well as other applications, such as hand held display devices. Embodiments disclosed herein are described with regard to augmented reality apparatus.

The display apparatus 200 includes a first waveguide 202, a second waveguide 204, and a third waveguide 206 for see-through viewing of an ambient environment 130 through the imaging structure 201, such as for a user viewing the environment 130 from a perspective 128. When implemented in a display apparatus 200, a first surface 224 of the first waveguide 202 is disposed adjacent to and facing a user's eye. A second surface 226 of the third waveguide 206 is disposed opposite the first surface 224 and the second surface 226 is disposed adjacent to and facing the ambient environment 130.

In one embodiment, the imaging structure 201 includes polarization switches 212, 214 which are utilized to rotate or cycle the polarization of the light 112 through polarization orientation angles before the light is reflected into the waveguides 202, 204, 206. In one embodiment, a first polarization switch 212 is coupled to the first surface 224 of the first waveguide 202 in the input coupling region 103. A second polarization switch 214 is coupled between the first waveguide 202 and the second waveguide 204 in the input coupling region 103.

The waveguides 202, 204, 206 include input reflectors 218, 220, 222 respectively, that are angled so that the first waveguide 202 has a first field of view and the second and third waveguides 204, 206, respectively, have a second field of view different from the first field of view. In addition the second waveguide 204 may have a second field of view different from a third field of view of the third waveguide 206. In one embodiment, the input reflectors 218, 220, 222 may be grating elements configured to deflect the light 112 propagating through the input reflectors 218, 220, 222. In certain embodiments, the input reflectors 218, 220, 222 are also wavelength filters selected to allow specific wavelengths of light either be reflected or transmitted through the input reflectors 218, 220, 222. For example, the input reflector 218 may be selected to reflect red light while allowing blue and green light to pass through, the input reflector 220 may be selected to reflect green while allowing blue light to pass through, and the input reflector 222 may be selected to reflect blue light.

In one embodiment, the first waveguide 202 includes the input reflector 218 which is implemented as a polarizing beam splitter or other type of optical filter to reflect the light that enters at a first polarization orientation angle so that the light propagates down the first waveguide 202. In this embodiment, the input reflector 218 is implemented to pass through the light 112 that enters the first waveguide 202 at a second polarization orientation angle as the polarization switch 212 rotates or cycles the polarization of the light 112 through the first and second polarization orientation angles. Similar to the first waveguide 202, the second waveguide 204 and the third waveguide 206 input reflectors 220, 222, respectively, may also be implemented as polarizing beam splitters.

The imaging structure 201 also includes a half wave plate 216 or similar optical element to change the light 112 (e.g. alter the polarization orientation of the light or select for a desired wavelength) that passes through the second waveguide 204. The half wave plate 216 is disposed between the second waveguide 204 and the third waveguide 206 in the input coupling region 103. A first interstitial space 208 is disposed between the first waveguide 202 and the second waveguide 204. A second interstitial space 210 is disposed between the second waveguide 204 and the third waveguide 206. The interstitial spaces 208, 210 are filled with a material having an index of refraction different than an index of refraction of a material selected for the first, second, and third waveguides 202, 204, 206. For example, the interstitial spaces 208, 210 may be filled with air which has an index of refraction of about 1.0 while the waveguides 202, 204, 206 may be fabricated from a transparent glass-like material having an index of refraction of greater than about 1.5. By utilizing material with sufficiently different indices of refraction, propagation of the light through the waveguides 202, 204, 206 may be enhanced by total internal refraction, or some degree thereof.

Generally, the input reflectors 218, 220, 224 are disposed in the input coupling region 103 of the imaging structure 201 and light propagates within the waveguides 202, 204, 206 through the waveguide region 105 to the output coupling region 107. Output elements 228, 230, 232 are disposed within the first, second, and third waveguides 202, 204, 206, respectively. The output elements 228, 230, 232 are generally considered to be output diffractive devices which direct light propagating through the waveguide region 105 toward a user's eye 111. Examples of suitable output elements 228, 230, 232 include focus elements implemented to change or adjust the focus depth of a displayed virtual image. One example of a focus element is a Switchable Bragg Grating. Alternatively, the output elements 228, 230, 232 may be more simplistic grating structures selected to reflect light in a direction aligned with a user's field of view.

The imaging structure 201 also includes a photochromic material layer 234 disposed on the second surface 226 of the third waveguide 206 adjacent the ambient environment 130. The photochromic material layer 234 is disposed over an area approximating the output coupling region 107. In this embodiment, the waveguide region 105 and the input coupling region 103 remain substantially free of the photochromic material layer 234. Similar to the photochromic material layer 126, utilizing the photochromic material layer 234 on the output coupling region 107, improved ambient light suppression and reaction to changing ambient light conditions provides for improved image display and viewing characteristics by suppressing ambient background light. Material and fabrication characteristics of the photochromic material layer 234 are similar to the photochromic material layer 126.

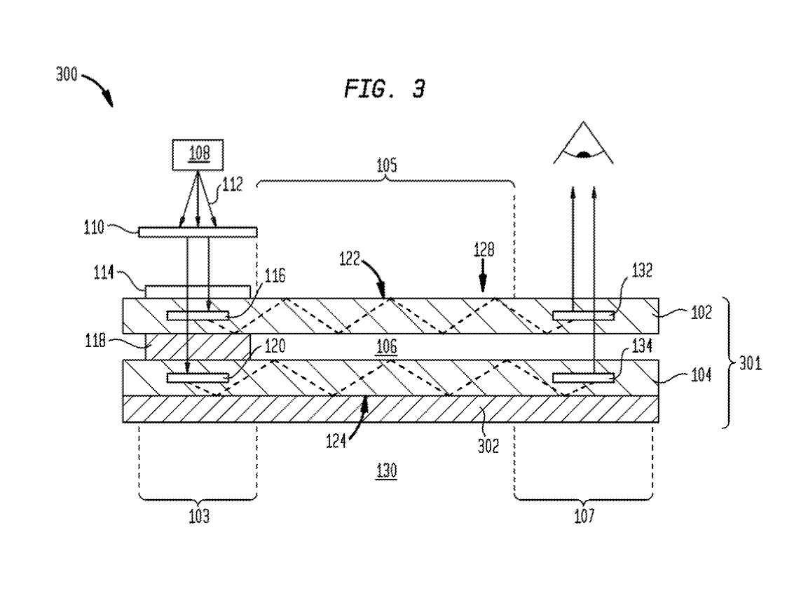

FIG. 3 is a schematic, cross-sectional view of a multiple waveguide imaging structure 301 according to an embodiment described herein. Similar to the imaging structures 101, 201, the imaging structure 301 may be implemented in a display apparatus 300 which is configured for either augmented or virtual reality applications.

The imaging structure 301 includes a photochromic material layer 302 disposed on the second surface 124 of the second waveguide 104. In this embodiment, the photochromic material layer 302 is disposed on the second surface in the input coupling region 103, the waveguide region 105, and the output coupling region 107. The photochromic material layer 302 may be disposed on the second waveguide 104 such that the photochromic material layer 302 covers the entire second surface 124. Alternatively, the photochromic material layer may be disposed on the second surface 124 in discrete regions approximating the input coupling region 103, the waveguide region 105, and the output coupling region 107. In another embodiment, a film is disposed between the photochromic materials layer 302 and the second waveguide 104. The film is formed from a material having an index of refraction less than an index of refraction of the materials selected for the second waveguide 104. It is believed that using the film with a reduced refractive index between the photochromic material layer 302 and the second waveguide 104, total internal reflection of light through the waveguide region 105 may be improved.

It is also contemplated that selected regions of the second surface 124 may be preferentially coated with the photochromic material layer 302. For example, the input coupling region 103 and the output coupling region 107 may be coated with the photochromic material layer 302 while the waveguide region 105 remains free from coating. In another example, the waveguide region 105 and the output coupling region may be coated with the photochromic material layer 302 while the input coupling region 103 remains free from coating. Various coating motifs may be utilized depending upon desired implementations. It is also contemplated that the embodiments and examples described with regard to FIG. 3 may be implemented on imaging structure having more than two waveguides, such as the imaging structure 201.

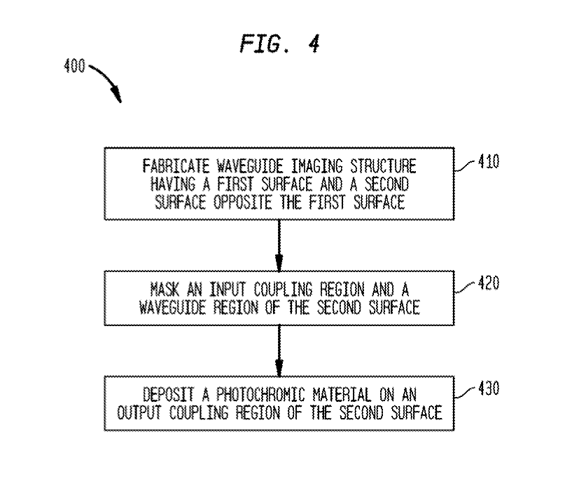

FIG. 4 is a flow chart of a method 400 for fabricating a waveguide imaging structure, such as the structures 101, 201, 301, having a photochromic material disposed thereon. At operation 410, a waveguide imaging structure having a first surface and a second surface opposite the first surface is fabricated. While exemplary imaging structures have been described with regard to FIGS. 1, 2, and 3, it is contemplated that the structures and method described herein may be advantageously employed on various other types of augmented and virtual reality imaging structures.

At operation 420, an input coupling region and a waveguide region of the second surface are masked. Materials suitable for masking include, but are not limited to, photoresist materials and hardmask materials, among others. The masking operation may also include a patterning operation to pattern the mask such that the output coupling region is exposed through the mask. At operation 430, a photochromic material is deposited on an output coupling region of the second surface. Subsequently, the mask may be removed from the input coupling and waveguide regions.

In summation, imaging structures incorporating photochromic material layers and methods for fabricating the same are described herein. The utilization of photochromic materials in such structures and devices is believed to improve image contrast, improve perceived image brightness, and prevent image washout. Thus, imaging structures having photochromic materials incorporated therein provide for an improved augmented reality image viewing experience and increase the utility of such devices in real world ambient light environments.

While the foregoing is directed to embodiments of the present disclosure, other and further embodiments of the disclosure may be devised without departing from the basic scope thereof, and the scope thereof is determined by the claims that follow.

What is claimed is:

1. An imaging structure apparatus, comprising:
a first waveguide;
a second waveguide spaced from the first waveguide, the first waveguide comprising a first surface of the imaging structure and the second waveguide comprising a second surface of the imaging structure, wherein the first surface is disposed opposite the second surface;
an input coupling region corresponding to a first area of the first waveguide and the second waveguide;
an output coupling region corresponding to a second area of the first waveguide and the second waveguide; and
a photochromic material layer disposed on the second surface corresponding to the output coupling region.

2. The apparatus of claim 1, wherein the first waveguide comprises:
a first input reflector disposed in the input coupling region of the first waveguide; and
a first output element disposed in the output coupling region of the first waveguide.

3. The apparatus of claim 2, wherein the second waveguide comprises:
a second input reflector disposed in the input coupling region of the first second waveguide; and
a second output element disposed in the output coupling region of the first waveguide.

4. The apparatus of claim 1, wherein a material selected for the first waveguide has a first refractive index and a material selected for the second waveguide has a second refractive index similar to the first refractive index.

5. The apparatus of claim 4, wherein an interstitial space between the first waveguide and the second waveguide has a third refractive index less than the first refractive index and the second refractive index.

6. The apparatus of claim 1, wherein the input coupling region and a waveguide region of the second surface remain uncoated by the photochromic material layer.

7. The apparatus of claim 1, wherein the photochromic material layer comprises one or more of titanium oxide, zinc oxide, tungsten oxide, nickel oxide, FeTiO₃, CdFe₂O₄, YFeO₃, SrTiO₃, CdO, V₂O₅, Bi₂O₃, PbO, Ta₂O₅, Nb₂O₅, SnO₂, ZrO₂, CeO₂, oxygen containing hydrides, lead titanate, lead-lanthanum titanate, oxides containing metallic or polymeric inclusions, zinc sulfide, lead sulfide, cadmium sulfide, oxide/sulfide composites, ZnSe, ZrSe₂, HfSe₂, and InSe.

8. The apparatus of claim 7, wherein the photochromic material layer comprises an oxygen containing yttrium hydride material.

9. The method of claim 1, wherein the photochromic material layer comprises a photoconducting polymers selected from the group consisting of polyvinyl carbazole materials, polythiophene materials, polyphenylene vinylene materials, polyphenylene materials, and polyaniline materials.

10. A display device apparatus, comprising:
a microdisplay;
imaging optics; and
an imaging structure having an input coupling region, a waveguide region, and an output coupling region, the imaging structure comprising:
a plurality of waveguides aligned in a stacked arrangement, wherein interstitial spaces are disposed between each waveguide; and
a photochromic material layer disposed on a surface of at least one waveguide, wherein the photochromic material layer is disposed on the surface approximating the output coupling region.

11. The apparatus of claim 10, wherein the imaging optics are disposed between the microdisplay and the imaging structure.

12. The apparatus of claim 11, wherein the photochromic material layer is disposed on the surface of a waveguide in the stacked arrangement furthest from the imaging optics.

13. The apparatus of claim 12, wherein the surface of the waveguide in the stacked arrangement furthest from the imaging optics further comprises the photochromic material layer disposed on an area of the surface approximating the input coupling region.

14. The apparatus of claim 13, wherein the surface of the waveguide in the stacked arrangement furthest from the imaging optics further comprises the photochromic material layer disposed on an area of the surface approximating the waveguide region.

15. The apparatus of claim 10, wherein the input coupling region and the waveguide region of the surface remain uncoated by the photochromic material layer.

16. The apparatus of claim 10, wherein the photochromic material layer comprises one or more of titanium oxide, zinc oxide, tungsten oxide, nickel oxide, FeTiO₃, CdFe₂O₄, YFeO₃, SrTiO₃, CdO, V₂O₅, Bi₂O₃, PbO, Ta₂O₅, Nb₂O₅, SnO₂, ZrO₂, CeO₂, oxygen containing hydrides, lead titanate, lead-lanthanum titanate, oxides containing metallic or polymeric inclusions, zinc sulfide, lead sulfide, cadmium sulfide, oxide/sulfide composites, ZnSe, ZrSe₂, HfSe₂, and InSe.

17. The apparatus of claim 16, wherein the photochromic material layer comprises an oxygen containing yttrium hydride material.

18. An imaging structure fabrication method, comprising:
fabricating an imaging structure comprising a plurality of waveguides, wherein a first waveguide defines a first surface of the imaging structure and a second waveguide defines a second surface of the imaging structure opposite the first surface;
depositing a mask on the second surface;
patterning the mask to expose an output coupling region of the imaging structure; and
depositing a photochromic material layer on the output coupling region of the second surface.

19. The method of claim 18, wherein the photochromic material layer is deposited by a chemical vapor deposition process.

20. The method of claim 18, wherein the photochromic material layer is deposited by a physical vapor deposition process.
